(19) United States
(12) Patent Application Publication
(10) Pub. No.: US 2025/0265197 A1
(43) Pub. Date: Aug. 21, 2025

(54) ADDRESS TRANSLATION

(71) Applicant: Arm Limited, Cambridge (GB)

(72) Inventors: Charles Andrew GIEFER, Spicewood, TX (US); Alexander Donald Charles CHADWICK, Cambridge (GB); Yuval ELAD, Cambridge (GB); Travis Bailey HAMILTON, Cedar Park, TX (US)

(21) Appl. No.: 18/442,220

(22) Filed: Feb. 15, 2024

(51) Int. Cl. G06F 11/10; G06F 12/1009

(52) U.S. Cl. CPC G06F 11/1016; G06F 11/1064; G06F 12/1009

(57) ABSTRACT

A memory management unit comprises an interface to receive an address translation request from a device, specifying a first address to be translated, and translation circuitry to translate the first address into a second address, wherein the translation is based on page table information corresponding to the first address. In response to the translation circuitry performing the translation without identifying a page fault associated with the first address, the interface is configured to send an address translation response to the device, the address translation response comprising the second address. The memory management unit comprises page request issuing circuitry responsive to the translation circuitry, in response to the address translation request, identifying a page fault associated with the first address, to issue a page request requesting that the page table information corresponding to the first address is updated to correct the page fault.

### BACKGROUND

### Technical Field

The present technique relates to the field of data processing. In particular, the present technique relates to address translation.

### Technical Background

A data processing apparatus may have a memory management unit (MMU) for managing accesses to memory. For example the MMU may be responsible for translating virtual addresses specified by a device wishing to access memory into physical addresses which directly identify the locations to access in memory. The MMU may also control whether a device is allowed to access the requested address based on access permissions set for regions of the address space.

### SUMMARY

At least some examples of the present technique provide a memory management unit comprising:

an interface configured to receive an address translation request from a device, the address translation request specifying a first address to be translated;

translation circuitry configured to translate the first address specified by the address translation request into a second address, wherein the translation is based on page table information corresponding to the first address,

wherein in response to the translation circuitry performing the translation in response to the address translation request without identifying a page fault associated with the first address, the interface is configured to send an address translation response to the device, the address translation response comprising the second address; and

the memory management unit comprises page request issuing circuitry responsive to the translation circuitry, in response to the address translation request, identifying a page fault associated with the first address, to issue a page request requesting that the page table information corresponding to the first address is updated to correct the page fault.

At least some examples of the present technique provide computer-readable code for fabrication of a memory management unit comprising:

an interface configured to receive an address translation request from a device, the address translation request specifying a first address to be translated;

translation circuitry configured to translate the first address specified by the address translation request into a second address, wherein the translation is based on page table information corresponding to the first address,

wherein in response to the translation circuitry performing the translation in response to the address translation request without identifying a page fault associated with the first address, the interface is configured to send an address translation response to the device, the address translation response comprising the second address; and

the memory management unit comprises page request issuing circuitry responsive to the translation circuitry, in response to the address translation request, identifying a page fault associated with the first address, to issue a page request requesting that the page table information corresponding to the first address is updated to correct the page fault.

The computer-readable code may be stored on a computer-readable storage medium. The medium may be non-transitory.

At least some further examples of the present technique provide a method comprising:

receiving an address translation request from a device, the address translation request specifying a first address to be translated;

performing a translation from the first address specified by the address translation request into a second address based on page table information corresponding to the first address;

responsive to the translation being performed without identifying a page fault associated with the first address, sending an address translation response to the device, the address translation response comprising the second address; and

responsive to the translation identifying a page fault associated with the first address, issuing a page request requesting that the page table information corresponding to the first address is updated to correct the page fault.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing system in which a number of devices access memory through a memory management unit;

FIG. 2 schematically illustrates an example where the MMU is distributed across several devices;

FIG. 3 schematically illustrates an example of a memory management unit according to examples of the present technique;

FIG. 4 schematically illustrates an example of a data processing system illustrating the storage of control information;

FIGS. 5A and 5B schematically illustrate example memory buffers acting as queues for transmitting messages;

FIG. 6 is a ladder diagram illustrating a process of automatically issuing a page request;

FIG. 7 schematically illustrates example encodings for messages which may be used in the present technique;

FIG. 8 is a flow diagram illustrating a method of automatically issuing a page request; and

FIG. 9 illustrates a system and a chip-containing product.

### DESCRIPTION OF EXAMPLES

An MMU may handle translations for a number of devices within a system which require access to a shared memory via the MMU. If multiple devices or contexts contend for access to memory through the same MMU (which may be referred to as an input-output MMU (IOMMU) and a system MMU (SMMU)), the contention can affect performance if the MMU has to delay performing a translation for one device whilst performing the translation for another device.

To reduce the performance impact of contention for MMU resource, some MMUs may provide an advance address translation function where a client device may send an advance address translation request to the MMU specifying a first address to be translated (e.g., a virtual address (VA) or an intermediate physical address (IPA)), and the MMU sends a response to the device specifying a second address (such as a physical address (PA)) corresponding to the first address. The first address may also be referred to as an untranslated address or input address, and the second address may also be referred to as a translated address or output address. The second address can be cached within the device, and later on the device can provide a translated memory access to the MMU specifying the previously cached second address. By performing the address translation operation ahead of time and caching the result in the device where it will not contend for MMU storage or bandwidth with other devices or contexts, performance at the time of performing the memory access can be improved. Performing the address translation ahead of time also has the advantage of identifying page faults (as discussed below) in advance of subsequent transactions which may attempt to access pages associated with a page fault. This enables page faults to be corrected ahead of said subsequent transactions so that those transactions are not blocked, and therefore can allow devices to interact with memory locations which would otherwise be associated with page faults (e.g., enabling a device to interact with memory which is not pinned).

Therefore, in some examples a memory management unit comprises an interface configured to receive an address translation request from a device, the address translation request specifying a first address to be translated. The address translation request may be referred to as an advance address translation request, as it may specify a first address corresponding to a memory location to be accessed at a later time in response to a subsequent translated memory access request from the device (in contrast to a demand address translation request which may request that the address is translated and that a memory access is carried out on the basis of the translated address). The memory management unit also comprises translation circuitry configured to translate the first address specified by the address translation request into a second address.

The device from which an address translation request is received is not particularly limited, and there may be several devices without an internal MMU which access memory via a shared MMU. For example, the device can include an I/O (input/output) device or hardware accelerator. An I/O device could include, for example, a display controller for controlling display of image frames on display, a network controller for controlling input or output of data via a network, or any other device for providing an interface between the processing system and the outside world. A hardware accelerator may perform certain dedicated processing functions in a more efficient manner than can be achieved using software executing on a generic processor such as the CPU. Other types of device are also possible.

The translation is based on page table information corresponding to the first address, where the page table information provides an indication of the second address. The page table information may be cached internally within the MMU in at least one translation lookaside buffer (TLB), or the MMU may access the page table information in memory to perform the translation (e.g., by performing a page table walk). The translation may be a one-stage translation (e.g., from VA-PA, VA-IPA, or IPA-PA), meaning that the page table information provides a direct translation from first address to second address based on a mapping specified in a single page table entry. However, in some examples the MMU may also support a multi-stage address translation such as a two-stage address translation where the mapping of a first address to a second address depends on both stage 1 page table information which maps the first address to an intermediate address and stage 2 page table information which maps the intermediate address to the second address.

In response to the translation circuitry performing the translation in response to the address translation request without identifying a page fault associated with the first address, the interface is configured to send an address translation response to the device, the address translation response comprising the second address.

However, if a page fault is identified then the MMU may be unable to perform a translation from the first address to the second address, and therefore unable to return the second address to the device in response to the address translation request. The MMU may be unable to resolve a page fault on its own. An update of the page table information may be required for the page fault to be resolved, to enable translation of the first address. The update may be carried out by device management circuitry, such as a CPU executing software configured to set page table information. A page request may be issued to notify the device management circuitry of the page fault and request that the page fault be corrected.

In one example technique, which is an alternative to the present technique, in response to the translation circuitry encountering a page fault when performing the translation in response to the address translation request, the interface may send a message to the requesting device indicating that a page fault was encountered. The requesting device may then issue a page request, requesting that the page fault be corrected. After receiving a response indicating that the page fault has been resolved, or after a particular amount of time has passed, the requesting device may reissue the address translation request to the MMU in the expectation that the page fault will have been corrected. However, the inventors have recognised that this technique is associated with several drawbacks.

For example, in the alternative technique each device may need to be configured to generate and issue a page request, adding complexity and increasing overhead of the requesting devices. In some examples this may involve generating a unique token (discussed below) which could add further complexity to requesting devices. Furthermore, the requesting devices may be subject to a quality of service protocol which limits the amount of bandwidth (e.g. on an interface between the devices and the MMU or other parts of the host system comprising the MMU) which can be used by a single device. Page requests issued by devices may consume bandwidth credits, leaving fewer credits for other requests, in a way which can be largely unpredictable and out of the control of the requesting devices (which may have no control over whether the address translation request will encounter a page fault). In addition, requiring requesting devices to issue page requests to software means that a page request interface is required to be exposed to the plurality of requesting devices, and this can lead to a number of issues. For example, a rogue requesting device could issue a large number of page requests to the interface which may prevent other devices from being able to have address translations or page fault corrections serviced (e.g., the rogue page requests may fill up a request queue).

In the alternative technique, details about the page fault may also be unavailable to the requesting device (e.g., whether it occurred in stage 1 or stage 2 of address translation, whether or not it is correctable, and so on). Further, compared to the technique which will be discussed below, the alternative technique is also associated with a greater number of messages transmitted over the interface between the devices and the MMU, associated with higher latency, additional power overhead, and higher bandwidth utilization.

The inventors have proposed the present technique to overcome these problems. According to the present technique, the memory management unit comprises page request issuing circuitry responsive to the translation circuitry, in response to the address translation request, identifying a page fault associated with the first address, to issue a page request requesting that the page table information corresponding to the first address is updated to correct the page fault. Hence, according to the present technique, page requests are issued directly by the MMU rather than by the requesting devices. The page request can be generated by the MMU as part of the procedure triggered by the address translation request received from the requesting device. This can overcome the problems discussed above. For example, a reduced number of messages may be required on an interface between the devices and the MMU, the page request interface may not need to be exposed to the devices, and devices can use bandwidth credits in a more predictable way. In some examples the requirement for requesting devices to be configured to issue page requests is removed, which also reduces the complexity of requesting devices.

In some examples, automatic generation of page requests by the MMU may be used in combination with explicit generation of page requests by requesting devices. In these examples, the automatic generation of page requests by the MMU can improve performance by allowing certain page faults to be corrected earlier, whilst retaining the issuing of page requests by devices means that minimal protocol changes are required for systems which were previously configured in such a way that devices were responsible for issuing page requests.

The page request may be handled asynchronously by software responsible for correcting the page tables. As the page fault may be raised in response to an advance address translation request, correcting the page fault is unlikely to be timing critical and therefore the page request may not cause an interrupt to be raised.

It is to be noted that although the page request is request for the page table information corresponding to the first address to be updated to correct the page fault, this does not necessarily guarantee that the page fault will be corrected every time a page request is issued. As discussed below there may be several reasons why a page fault is unable to be corrected. Even if a particular page fault is found to be non-correctable, the advantages of the present technique are still achieved because of the removal of the requirement for devices to be configured to send page requests.

In some examples, the interface may be configured to send a page fault response to the device, the response indicating that the page request issuing circuitry has issued the page request. By sending a page fault response to the requesting device, the requesting device is able to identify that a page fault was encountered and that a page request has already been issued. Knowing that a page request has been issued, the device may wait to receive a response to the page request before issuing a further address translation request specifying an address in the same page. Therefore, sending a page fault response to the device may reduce the number of unnecessary address translation requests sent by the device, improving performance of both the device and MMU and reducing unnecessary bandwidth usage on the interconnect.

In some examples, software may provide an indication to the MMU when a particular page fault has been corrected. Whilst various techniques could be used to associate an indication from software with a particular page request, in one particularly effective example page requests may be associated with page request tokens and software may specify the token included in a particular page request when indicating that a page fault has been corrected in response to that particular page request. Therefore, in some examples, the page request issuing circuitry may be configured to generate a page request token and assign the page request token to the page request. The page request token is not particularly limited, and in some examples may comprise a token value which is unique for a particular page in the address space of the first address (or unique for a particular combination of first address and address translation context).

It will be appreciated that generation of page request tokens is not required for the present technique, as in some examples a requesting device may receive no indication of whether a particular page fault has been corrected and therefore does not need to associate an indication with a particular page request. However, in examples which support token generation, providing page request token generation functionality in the memory management unit is associated with advantages. Token generation in the MMU is in contrast to techniques which involve devices issuing page requests themselves, where page request token generation circuitry may be provided in each device so that each device can assign tokens to page requests. In examples where the MMU generates the page request tokens, the overhead of providing circuitry for generating tokens may be reduced because token generation circuitry can be shared between several devices rather than being provided in each device. Therefore, overhead can be reduced by providing page request issuing circuitry configured to generate page request tokens to be assigned to page requests.

In some examples where the interface is configured to send a page fault response to the device indicating that the page request issuing circuitry has issued a page request, the page fault response may indicate the page request token assigned to the page request. By providing the page request token to the device, the device is able to associate a particular address translation request with any future messages associated with the page request token, such as a message indicating that the page fault has been resolved. The device may provide storage to store the tokens, but the device is not required to generate tokens and therefore is able to benefit from the assignment of tokens to page requests without incurring the cost of token generation.

In some examples, a requesting device may receive no indication of whether a particular page fault has been corrected. The device may periodically resend an address translation request after sending an initial address translation request, or after receiving a page fault response, or may rely on some other event to identify when to resend an address translation request. However, in some examples devices may receive an indication that a page fault has been resolved, and this may be used by the device to trigger resending of an address translation request. This can be more efficient as devices can wait until receiving confirmation that a page fault has been corrected before issuing a request and therefore reduce unnecessary requests. The MMU may be configured to send, to the device, a page corrected response in response to determining that the page fault associated with the first address has been corrected. For example the MMU may be configured to receive a response from the software (e.g., via a command queue, discussed below) indicating that the page fault has been corrected. The page corrected response sent to the device may indicate the page request token assigned to the page request, allowing the device to determine which page fault was corrected and therefore which address translation request can be resent.

The manner in which the page request issuing circuitry is configured to issue a page request in response to an address translation request encountering a page fault is not particularly limited. For example, a page request message may be transmitted directly to a CPU. As discussed above a page request may not be particularly time critical. In some examples, therefore, the page request issuing circuitry may be configured to issue the page request to a page request queue. The page request queue may provide a mechanism for a page request handler to correct page faults asynchronously when it is free to do so. This may be in contrast to examples where a page fault is encountered on a demand access (rather than an address translation request), where resolving the page fault for the demand access may be timing critical and therefore may cause an interrupt to be generated.

The page request queue may be provided as a structure in a region of memory accessible to the device management circuitry (e.g., the device management circuitry may comprise a CPU executing software such as an operating system or hypervisor) responsible for controlling the assignment of memory pages. As the device management circuitry and the MMU may share access to the same memory system, messages may be transmitted between the two by writing to and reading from a particular region of memory. This provides a particularly effective mechanism for the MMU to issue page requests, as reduces the need for a dedicated hardware signal interface between the MMU and CPU (separate from the memory system interface) and is more scalable to handle different numbers of devices associated with the MMU.

As mentioned above, there can be many reasons that a page fault may be encountered when attempting to translate a first address into a second address. In general, the page fault indicates that the translation cannot be completed, but this may be for several reasons. For example, the translation circuitry may determine that the first address does not correspond to valid page table information. For example, there may be no valid page table entry defined in memory corresponding to the first address. This situation may arise when a physical page of memory has not yet been allocated to the first address and therefore a corresponding page table entry has not been created. Alternatively, page table information may be provided corresponding to the first address but that page table information may indicate that the requesting device is not allowed to access the memory location corresponding to the first address. For example, the device may not have permissions required to access the physical page in memory corresponding to the first address.

Certain page faults may be correctable, meaning that the entity responsible for controlling the assignment of memory pages is able to correct the page fault by updating the page table information. In some examples, the first address may not be associated with a page of physical memory at all. In this case, a free physical page in memory may be allocated to the first address, or if no physical pages of memory are free then a physical page may be allocated by swapping data for another virtual page out to off-chip memory. Once a page has been allocated, then the page table information may be updated to identify the allocated page in memory. In other examples, a page fault may be corrected by updating the permissions associated with the page of physical memory to enable access from the requesting device.

However, certain page faults may be non-correctable. For example, the first address may not be within a valid address space, meaning that it may not be possible for there to be a corresponding page in memory. Alternatively, the MMU may not have access to the region of memory associated with the first address. Alternatively, regardless of the particular page fault, the mechanism for issuing page requests may be unavailable (e.g., the page request queue is not configured), meaning that the page fault cannot be corrected because a page request cannot be issued. If a particular device were unaware that the page fault encountered in response to an address translation request for a particular address was a non-correctable page fault, then it may continue to issue address translation requests for that same address as it may never receive a page corrected response. This could lead to a large amount of wasted power and bandwidth. Therefore, in some examples, responsive to the translation circuitry identifying a non-correctable page fault associated with the first address, the interface may be configured to send a non-correctable page fault response to the device indicating that a non-correctable page fault was encountered. The page request issuing circuitry may also be responsive to the determination that a non-correctable page fault was encountered to suppress issuing of a page request. The non-correctable page fault response enables a device to determine that sending of further address translation requests for the particular first address would not be useful, and therefore can reduce the volume of address translation requests in the system.

As mentioned above, the first address may be a virtual address. The second address obtained by translating the first address may be a physical address indicating the physical location in memory to which a subsequent memory access request should be directed. The translation from virtual to physical address may be 1-stage (dependent on a single page table structure traversal to locate a mapping value specifying the mapping from virtual address direct to physical address) or it may be a 2-stage translation via an intermediate physical address which is not necessarily returned to the requesting device. In other examples, the second address may be an intermediate physical address returned to the device. Returning an intermediate physical address (IPA) to a device may be useful because it can reduce contention for the MMU when carrying out the later memory access (because the VA-IPA translation is performed in advance) without exposing a physical address to the device, as for example exposing a physical address to the device may be associated with security risks. In yet further examples the first address may be an IPA (e.g., returned in response to a previous VA-IPA address translation request) and the second address may be a physical address. It will be appreciated that these options are not limiting, and the techniques discussed herein may apply to many examples of translation from a first address to a second address in response to an address translation request.

In some examples, the page request issuing circuitry may be configured to issue a page request automatically in response to identifying a page fault. However, there may be certain situations where this behaviour is undesirable. For example, one or more devices in a system may already be configured to issue page requests and therefore issuing of page requests by the MMU may be unnecessary for address translation requests issued by those devices. In other examples a programmer may wish to prevent the issuing of page requests for various reasons, for example to disable allocation of new memory pages for one or more devices. In any case, flexibility and control can be increased by providing a mechanism for disabling the automatic issuing of page requests for address translation requests originating from at least one of the devices.

Therefore, in some examples, the page request issuing circuitry may operate in one of at least two modes. In a first page fault mode the page request issuing circuitry may be responsive to the translation circuitry identifying the page fault in response to the address translation request to issue the page request, and in a second page fault mode the page request issuing circuitry may be responsive to the translation circuitry identifying the page fault in response to the address translation request to suppress issuing the page request as a response to the address translation request. In the second page fault mode the interface circuitry may also be responsive to the translation circuitry identifying the page fault in response to the address translation request to send a page fault response, to the device, indicating that the page fault has been encountered. The first and second page fault modes may be specific to address translation requests originating from one or more specific devices, or may apply to all address translation requests.

The selection between first and second page fault modes may be controlled in various ways. In some examples, the selection of page fault mode may be hardwired for particular devices (e.g., depending on whether those devices are configured to issue page requests). However, in some examples the page request issuing circuitry may be configured to select whether to use the first page fault mode or the second page fault mode in dependence on control information accessible to the page request issuing circuitry. The control information may be set by software, and/or may be based on an input from a programmer configuring the system. For example, the control information may be stored in one or more registers in the devices, in the MMU, in a CPU within the system, or elsewhere. The control information may also be stored in memory.

In some examples, the page request may specify only the first address. However, in a system using virtual memory there may be several address translation contexts, where the same first address in different contexts is translated into different second addresses. For example, this can allow several devices to execute different instances of the same code referencing the same virtual addresses, whilst being mapped to different physical locations to allow the different instances of code to be executed concurrently. Therefore, both the address translation requests and the page requests may also specify an address translation context corresponding to the first address, to enable identification of the page table information corresponding to the first address.

Examples will now be described with reference to the figures.

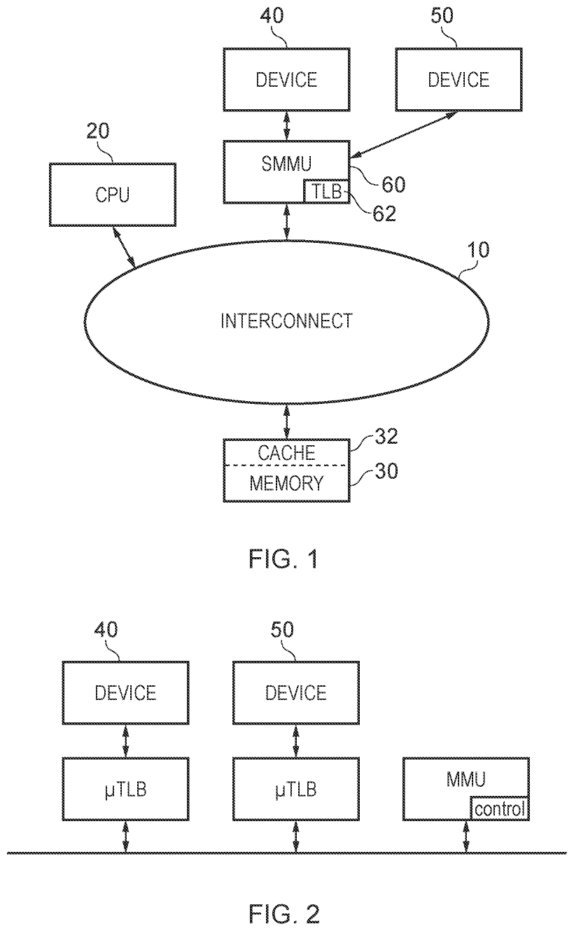

FIG. 1 schematically illustrates an example of an apparatus (e.g. a data processing system, integrated circuit or system on chip) having at least one processor 20. In this example the processor is a CPU (Central Processing Unit), but other examples of processors include a GPU (Graphics Processing Unit) or NPU (Neural Processing Unit—a type of processor with specialized hardware for accelerating vector and/or matrix operations or other operations used in Neural Network and other machine learning processing). While FIG. 1 only shows one such processor, it will be appreciated that system could have two or more such devices, which may include further CPUs or could include other types of instruction execution devices such as a graphics processing unit (GPU). The processor has an internal memory management unit (MMU) which functions as address translation circuitry for translating virtual addresses specified by instructions executed by the processor into physical addresses identifying locations within the memory system. The MMU may have at least one TLB for storing translation information which depends on page table data from page table structures stored in the memory system. The page table structures define the address mappings between virtual and physical addresses and may also define memory access permissions which may define whether certain software processes executing on the processor are allowed to access certain addresses.

In addition to the processor or other devices capable of instruction execution which have their own internal MMU, the system may also include one or more devices 40, 50 which may not have an internal MMU, and so for accessing memory and providing address translation functionality, such devices may communicate with the rest of the system via a system memory management unit (SMMU) 60 which includes address translation circuitry which controls address translation and memory permissions based on translation data defined in page table structures in memory. Again, the SMMU 60 may have one or more TLBs 62 which have a similar functionality to the TLB within the MMU of the processor 20. The devices 40, 50 which access memory via the SMMU 60 can include cached devices which include an internal cache and uncached devices which do not have any cache. For example, a device 40, 50 could include a display controller for controlling display of image frames on display, a network controller for controlling input or output of data via a network, a hardware accelerator for performing certain dedicated processing functions (e.g. cryptographic processing, or neural network processing) in a more efficient manner than can be achieved using software executing on a generic processor such as the processor 20, and so on (e.g. other types of I/O device other than a display controller or network controller).

All of the units 20, 40, 50 communicate with each other via an interconnect 10 which is responsible for routing transactions between the requester devices and memory 30. Interconnect 10 may also be responsible for managing coherency between data cached in respective caches of the system. It will be appreciated that FIG. 1 is a simplified diagram and the system may have many other components not shown in FIG. 1 for conciseness.

The TLB 62 stores recently or commonly used translations between virtual and physical memory addresses. So, as a first step in an address translation process, the TLB 62 is consulted to detect whether the TLB already contains the required address translation. If not, then a more involved translation process may be used, for example involving consulting so-called page tables holding address translation information, typically resulting in the TLB 62 then being populated with details of the required translation.

The virtualized system of FIG. 1 may make use of multiple stage address translation. A virtual address (VA) required by an executing program or other system module in one of the devices 40 is translated to an intermediate physical address (IPA) by a first MMU stage. As far as the VM software is aware, the IPA is a physical address used to access the system memory. However, the virtualized system provides a second level of address translation such that the IPA is then translated to a physical address (PA) by a second MMU stage. The IPA to PA translation is wholly under the control of the hypervisor. So, a particular VM may be exposed to the VA to IPA translation, whereas the hypervisor has oversight of the IPA to PA translations and therefore control of real accesses to the physical system memory.

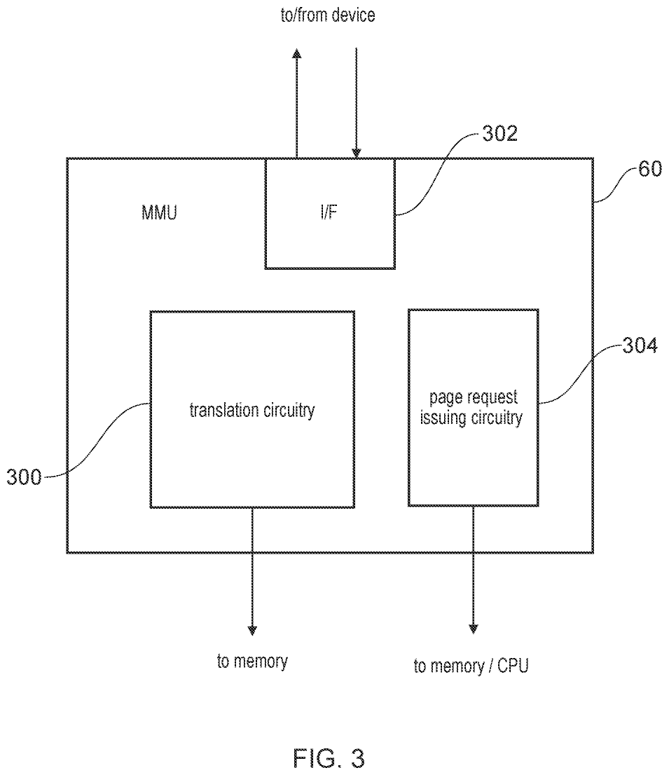

FIG. 1 shows the use of one SMMU 60. In other examples, such as that shown in FIG. 2, the memory management unit functionality may be, in part, distributed in that TLBs may be respectively associated with each device. In the example shown in FIG. 2, certain translations which are able to use translation information cached locally in a TLB of that device (which may be referred to as a micro TLB (μTLB)) may take place locally to the device. However, even if certain translations may take place locally at certain devices, the MMU is still provided to populate the μTLBs. If a required translation is not found in the respective μTLB (a TLB “miss”), then an address translation request is issued to the central MMU specifying a first address and requesting translation of the first address. The central MMU translates the first address into a second address using page table information specified in a TLB or in memory, in the same way as the MMU shown in FIG. 1. The MMU of FIG. 2 may therefore be configured in the same way as the MMU of FIG. 1. If the central MMU performs the address translation without encountering a page fault, then it returns an address translation response to the device, the address translation response comprising the second address and enabling the device to cache the translation from the first address to the second address locally in its μTLB.

FIG. 3 schematically illustrates an SMMU 60 according to examples of the present technique (which could correspond to either the SMMU 60 shown in FIG. 1 or the MMU shown in FIG. 2). The SMMU 60 has a device interface 302 for receiving requests from the devices 40, 50 and transmitting responses to the devices 40, 50. For example, the SMMU 60 may be coupled to the devices 40, 50 via a bus such as a PCI bus, and the device interface 302 may implement the bus protocol used for transmitting signals over the bus.

The SMMU 60 also has translation circuitry 300 configured to perform address translation from a first address to a second address. For example, the first address may be provided to the translation circuitry 300 from the interface 302 in response to the interface 302 receiving an address translation request from one of the devices 40, 50. The translation circuitry 300 is configured to look up a TLB 62 provided in the SMMU 60 to determine whether a page table entry indicating a translation has previously been cached to provide the translation. If not, then the translation circuitry 300 carries out one or more accesses to memory 30 to perform the translation. The memory accesses access page tables stored in the memory system 30, 32. The location in memory storing the page tables may be indicated by control information stored in a control register or other structure provided within, or accessible to, the SMMU 60.

For example, the page tables may include S1 page tables and S2 page tables.

The S1 page table provides information defining how to perform the S1 address translation of VAs to IPAs. The S1 page tables are set by the CPU 20 under control of a guest operating system or virtual machine. The S1 page table may define, for each page of the virtual address space, a mapping between a page portion of the virtual address and a page portion of the corresponding intermediate physical address (typically the address also includes an offset portion which remains unchanged during the translation). The S1 page table may also define access permission data for controlling whether to allow a memory access to a given address from a particular device or context. The S1 page table may include several levels of page table. When an S1 translation is required, if the required page table entry is not in the S1 TLB then a page table walk operation is performed to fetch the entry from one of the levels of S1 page tables in memory, and when the required page table entry is brought into the S1 TLB then the S1 translation can proceed. The page table walk operation may be relatively slow and if there is significant contention between different devices or contexts for space in the S1 TLB then this may reduce the performance of the SMMU since it will not be possible to service memory access requests as quickly.

Similarly, the S2 page tables define mappings between the page portions of IPAs and PAs (again an offset portion of the address may remain unchanged), and permission data for controlling whether to permit an access to a given address. The S2 page tables may be set under control of the hypervisor. Again, a S2 TLB can be provided on chip within the SMMU for caching some of the page table entries from the S2 page table, and page table walks can be performed to fetch required page table entries into the S2 TLB. The PA returned by the S2 translation can then be returned to the device 40, 50 which issued the address translation request. Alternatively, a combined S1+S2 TLB may be provided in the SMMU 60 to cache mappings direct from VAs to PAs, where each VA-PA mapping is derived from separate VA-IPA and IPA-PA mappings obtained from the S1 and S2 page tables respectively.

The translation circuitry 300 of the SMMU 60 may identify page faults during the process of performing an address translation. For example, a page table entry corresponding to the first address (or an intermediate address calculated from the first address) may not be provided in memory 30, meaning that the translation circuitry 300 finds no valid mapping from the first address to the second address. This may be caused because a physical page of memory has not been allocated to the first address, or because an error has occurred in the setting of page tables causing a page table lookup to be made in a memory location for which the stored data is not in a valid page table format. A page fault may also be encountered if a page table entry is provided for the first address, but the page table information indicates that translation is not possible for some other reason, for example if the permissions indicated in the page table information prohibit the page being accessed in the manner requested (e.g. a write being requested to a read-only page).

The page tables are set by software (e.g., the stage 1 address translation data may be set by an operating system or virtual machine, and the stage 2 translation data may be set by a hypervisor). Therefore, a request is sent to software to request that the page faults be corrected. In some alternative examples, devices 40, 50 may be responsible for issuing requests to software. However, the SMMU 60 according to the present technique comprises page request issuing circuitry 304. In response to determining that a page fault has been encountered, the page request issuing circuitry 304 issues a request, visible to software, to request that the page tables are updated to correct the page fault.

By arranging the SMMU 60 to issue the page request, rather than the devices 40, 50, the devices can be designed with reduced complexity as they do not need to provide the functionality required to generate page requests. In addition, this technique is associated with fewer issues with software responsible for handling page requests, as the software is not exposed to the devices directly and therefore cannot be disrupted by a rogue device 40, 50 issuing a large number of rogue page requests.

Further, the protocol via which data is sent over the interconnect 10 may impose restrictions on the amount of bandwidth which can be used by each device 40, 50. If devices 40, 50 were responsible for issuing page requests then those devices may use bandwidth credits for page requests. However, this can affect performance in an unpredictable way, since using bandwidth credits for issuing page requests can reduce the number of credits available for other requests such as memory access or translation requests which may be associated with the performance of the device. The number of page faults encountered by a particular device is generally unpredictable and may vary each time a program is run, so requiring those devices to issue page requests can affect performance in unpredictable ways. By providing page request issuing circuitry in the MMU 60, this problem can be reduced.

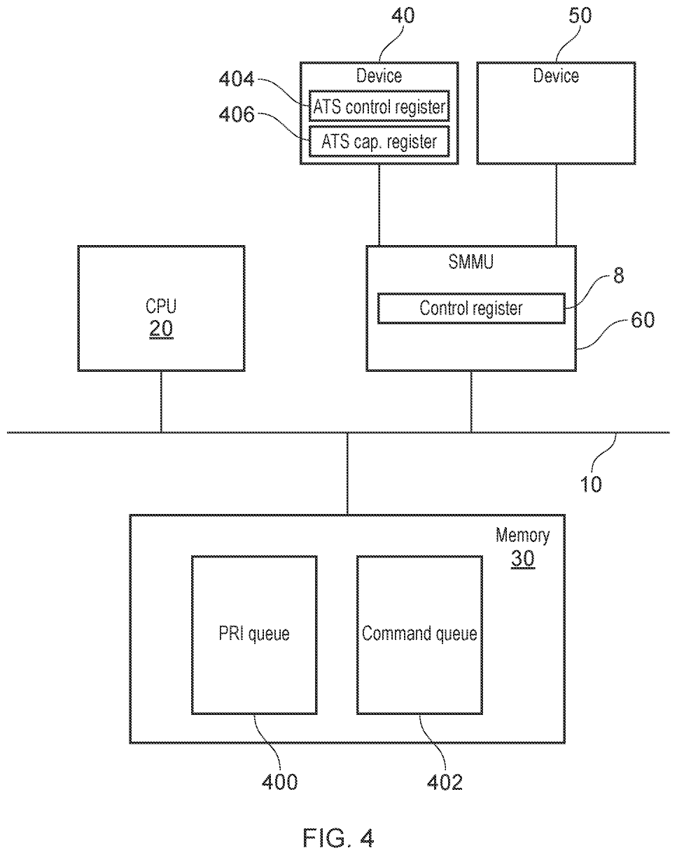

FIG. 4 shows the system of FIG. 1, illustrating in greater detail control structures in the system for controlling the performance of address translation.

FIG. 4 shows that one or more devices 40 may comprise control registers for controlling whether and how that device may issue address translation requests. For example, the device may provide an address translation service (ATS) control register 404, and an ATS capability register 406. The registers 404, 406 may comprise one or more bits which, when set to a particular value, indicate that the device supports the SMMU 60 automatically issuing page requests when encountering a page fault in response to an address translation request from that device. For example, the bits may indicate that the device is configured to receive a page fault response from the SMMU 60 and extract from that page fault response a page request token generated by the SMMU 60. The encoding of the bits indicating whether the device supports automatic page request generation by the SMMU 60 may be such that the encoding representing that the device does not support automatic page requests would match the encoding of reserved bits of registers 404, 406 in a legacy device not designed to support automatic page requests.

The SMMU 60 may also comprise one or more control registers 8. In one example, the control registers 8 may indicate, for each of the devices 40, 50, whether the SMMU 60 should automatically issue page requests when encountering page faults during handling of address translation requests from that device. Hence, the control registers 8 may provide control information accessible to the SMMU 60 for controlling whether address translation requests from a particular device should be handled in a first page fault mode in which page requests are generated automatically or a second page fault mode in which page requests are not automatically generated, and in which a response may be sent to the device to enable the device to generate and issue its own page request.

The SMMU 60 has access to at least two queue structures in memory 30, including a command queue 402 and a page request interface (PRI) queue 400. The memory 30 is accessible to both the SMMU 60 and the CPU 20, and therefore provides a mechanism by which messages can be transmitted between the CPU 20 and the SMMU 60.

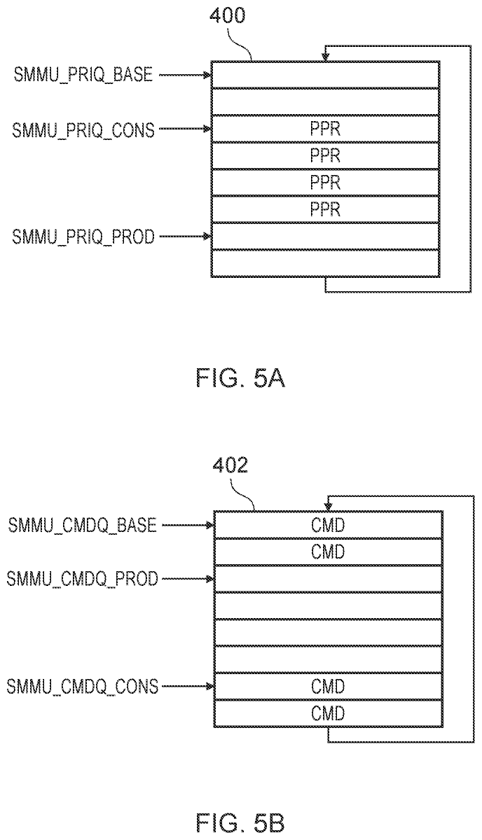

The PRI queue 400 is written to by the SMMU 60 and is read by the CPU 20, and enables page requests to be issued from the page request issuing circuitry 304 of the SMMU 60 to the CPU 20, on which the software controlling the page tables is executed. The PRI queue may have a circular buffer structure as illustrated in FIG. 5A.

FIG. 5A shows the PRI queue as a series of memory locations, starting at the memory location indicated by the base address pointer SMMU_PRIQ_BASE. The size of the PRI queue may be variable, and the size may be indicated by a value in a configuration register. This variable size enables the PRI queue to easily scale (vary in size) depending on system requirements (e.g., it may be larger in systems having a greater number of devices 40, 50), illustrating an advantage of implementing the PRI queue in memory. The PRI queue is a circular buffer, meaning that it is treated as though it were connected end-to-end (illustrated by the arrow which connects the bottom location to the top), meaning that if memory locations were in general accessed in sequence from the top of the illustrated structure to the bottom, then the next location in memory after reaching the location shown at the bottom of the structure is the location shown at the top of the structure.

The SMMU 60 writes page requests to the PRI queue and the CPU 20 reads page requests from the PRI queue, asynchronously. Upon writing to the PRI queue, the SMMU 60 increments the producer pointer SMMU_PRIQ_PROD to indicate the next location to be written to by the SMMU 60. The pointer SMMU_PRIQ_PROD may for example provide an offset which is added to the based address indicated by SMMU_PRIQ_BASE. If the location indicated by the pointer after incrementing is outside the range of the buffer, then the pointer is set to the base address (and in this way the buffer is a circular buffer). The CPU reads page requests from the address indicated by the consumer pointer SMMU_PRIQ_CONS, and increments the consumer pointer to identify the next page request to be read. A comparison between the pointers SMMU_PRIQ_PROD and SMMU_PRIQ_CONS allows the SMMU to determine when the PRI queue is full (e.g., when the two pointers point to the same location or neighbouring locations), and therefore prevent the SMMU from overwriting unread page requests (which due to the circular nature of the PRI queue would otherwise be a concern). It will be appreciated that although a circular buffer is shown, other memory structures could be used to implement the PRI queue 400.

The command queue 402 is written to by the CPU 20, and allows the CPU 20 to send messages to the SMMU 60. For example, the CPU 20 may issue a page corrected response to the SMMU 60 to indicate that software executing on the CPU 20 has corrected a page fault in response to a page request issued by the SMMU 60. The command queue 402 may have a circular buffer structure as illustrated in FIG. 5B, controlled by pointers in a similar manner to the PRI queue 400 discussed with reference to FIG. 5A, but for the command queue 402 the consumer is the SMMU 60 and the producer is the software executing on the CPU 20, in contrast to the PRI queue for which the consumer is the software executing on the CPU 20 and the producer is the SMMU 60. FIG. 5B shows how the pointers may wrap around after reaching the end of the circular buffer, showing the producer pointer at the top of the structure after previously reaching the end of the buffer.

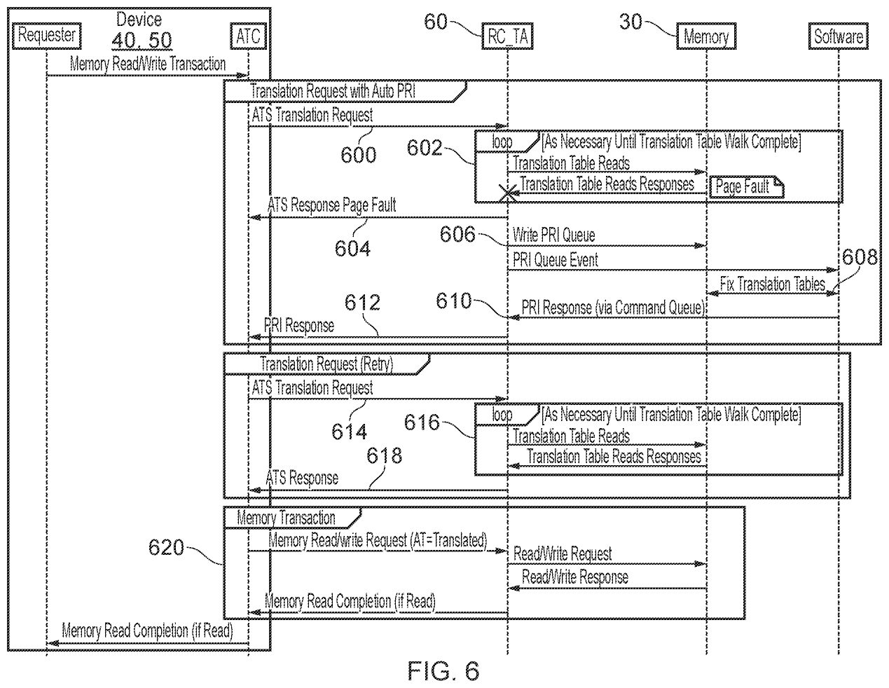

FIG. 6 is a ladder diagram illustrating a method of automatically issuing a page request using the MMU 60 in response to encountering a page fault when performing a translation in response to an address translation request.

At stage 600, the device 40, 50 issues an address translation service (ATS) address translation request to the SMMU. This request may be issued to allow processing circuitry of the device to issue a memory access request (e.g., a read or write) by obtaining a physical address corresponding to a virtual address used by the processing circuitry. A lookup may first be performed in a TLB (or address translation cache ATC) to determine whether the device 40, 50 already has a copy of the translation and if not, then this may trigger issuing of the ATS request. The ATS request allows an address translation to be obtained in advance, before the translation is required by the device 40, 50, to reduce the likelihood of encountering delays at the time of the memory access request which may arise when several devices are contending for SMMU resource.

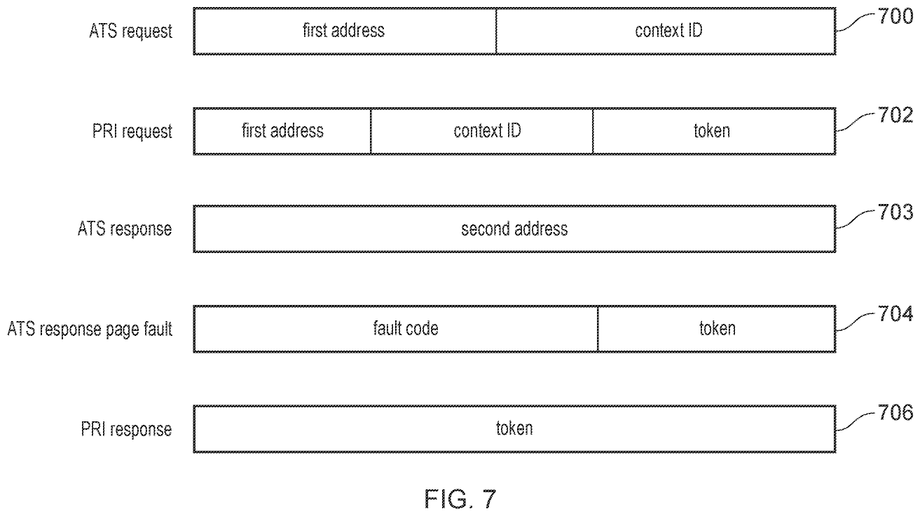

As shown in FIG. 7, the ATS request 700 specifies the first address for which a translation is required (e.g., a VA or IPA) and additionally specifies an address translation context identifier which can be used to select the correct set of translation tables to perform the translation.

The ATS request is received by the SMMU 60 (shown in FIG. 6 as the root complex translation agent RC_TA) which at step 602 attempts to translate the first address into a second address. For example the SMMU 60 may first perform a lookup in a TLB to determine whether the SMMU 60 has a cached copy of a translation of the first address. If not, then a series of reads to the translation tables stored in memory 30 may be carried out.

The series of reads may be carried out as part of a multi-level page table walk in which a read is performed to a first page table entry in memory (belonging to a page table corresponding to the context ID specified in the ATS request), where that entry identifies a further page table entry at a different location in memory, and so on until an entry is reached which provides page table information including the translation from the first address to the second address.

A page fault may be identified during the process 602 of translation. For example, it may be found that there is no valid page table entry corresponding to the first address. Alternatively, a valid page table entry may be identified but that entry may indicate that an access to the memory location identified by the first address is not permitted.

If no page fault is encountered then the SMMU 60 may return an ATS response (703 as shown in FIG. 7) to the device including the second address.

However, if a page fault is encountered at step 602 then the SMMU 60 is unable to return the second address. Instead, the SMMU 60 generates a page request and, in the process illustrated in FIG. 6, at step 606 automatically issues a page request to the page request queue 400. Whether or not a page request is automatically issued from the MMU may be configurable for each device, and hence may depend on control information set in control registers of the requesting device, although in the example of FIG. 6 these registers indicate that a PRI request should be automatically generated. An example encoding of the PRI request 702 is shown in FIG. 7. The PRI request is issued by writing the PRI request to the memory location indicated by the SMMU_PRIQ_PROD pointer.

The PRI request 702 includes the first address and context ID specified by the ATS request 700 to enable the relevant page table information to be identified. The PRI request also includes a token. The token is generated by the SMMU 60 and allows future messages relating to the PRI request (e.g., a PRI response) to be associated with the PRI request 702. The token may be generated in various ways, and can generally be any value which distinguishes different PRI requests from each other. The token can be an arbitrarily selected value which satisfies this purpose, such as a value selected according to a counter incremented each time a PRI request is generated.

The SMMU 60 also generates and sends an ATS page fault response 704 to the requesting device 40, 50 at step 604. The ATS page fault response informs the requesting device that a page fault was encountered.

An example encoding of the ATS page fault response 704 is shown in FIG. 7. The requesting device may differentiate an ATS response 703 and an ATS page fault response 704 in several different ways. For example, a reserved field in the ATS response may be used, or an existing field repurposed, to identify whether the response is to be interpreted as an ATS page fault response 704.

The ATS page fault response 704 includes a fault code field. The fault code lets the device know what type of page fault was encountered. For example, the fault code field may indicate whether the fault is one of: non-recoverable, recoverable and a page request has been automatically generated, and recoverable but a page request has not been automatically generated.

If the page fault is non-recoverable then the page fault may not be corrected. By communicating that a non-recoverable fault was encountered, the ATS response can enable a device to suppress further ATS requests for the first address encountering the non-recoverable fault and therefore reduce wasted power and bandwidth overhead.

If the page fault is recoverable but a page request was not automatically generated, then this may prompt the device to generate and issue a PRI request to the PRI queue to request that the page fault be corrected.

If the page fault is recoverable and a page request was automatically generated (at step 606) then the device may also be configured to extract from, and store locally, the ATS page fault response 704 the token which was generated by the SMMU and which was included in the PRI request 702. By communicating the token to the device, the SMMU enables the device to identify future messages associated with the PRI request.

In response to the PRI request, at step 608 software (e.g., a virtual machine or hypervisor) corrects a page fault by updating the relevant entry of a relevant page table. This may also involve allocating or swapping memory pages if required. Once a particular page fault has been corrected, then at step 610 the software may signal this to the SMMU 60 via a PRI response.

The PRI response may, for example, be written to the command queue structure 402 in memory 30, at the location indicated by the pointer SMMU_CMDQ_PROD (which may provide an offset to be added to SMMU_CMDQ_BASE).

The SMMU 60 may then forward the PRI response to the device at step 612. As shown in FIG. 7, the PRI response 706 may include an indication of a token. By associating the token in the PRI response with the token received in the earlier ATS response 704, the device is able to identify which first address is the address for which the page fault has been corrected.

At step 614, the device reissues an ATS request 700 specifying the first address for which a PRI response was received at step 612, in the expectation that the translation will now be performed (at step 616) without encountering the page fault. If this is the case as shown in FIG. 6, then at step 618 the SMMU 60 may return the second address to the requesting device in an ATS response (with U=0).

The device may cache the second address, and at a future point (step 620) may issue a memory access request (e.g., a read or write) specifying the second address, to reduce or eliminate the translation that is required at that point.

It will be appreciated that the encodings shown in FIG. 7 are merely examples. Further fields may be included in such encodings to enable further information to be transmitted. For example, a field may be provided in the PRI response 706 indicating whether the page fault has been corrected successfully or not.

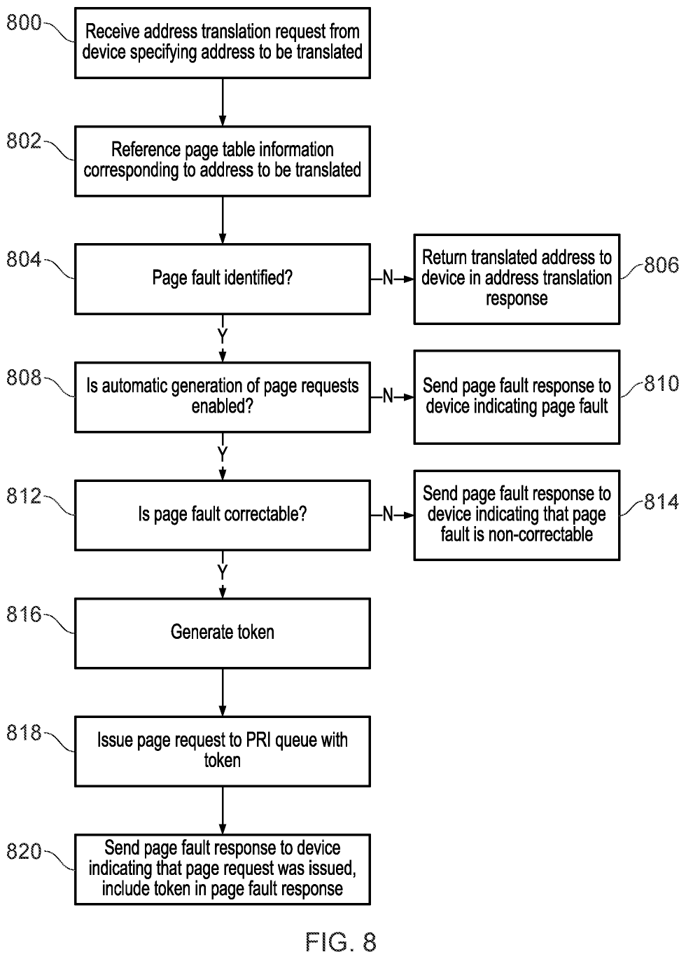

FIG. 8 is a flow diagram illustrating a method for a memory management unit of automatically issuing a page request.

At step 800 the MMU receives, via an interface 302, an address translation request specifying a first address (and optionally context information to enable a correct page table to be identified).

At step 802, the translation circuitry 300 of the MMU 60 performs a lookup in an internal TLB to determine whether a translation is available. If a translation is not cached in the TLB, then the translation circuitry 300 performs a series of accesses to page tables in memory 30 to locate page table information corresponding to the first address, to enable a translation to be performed.

At step 804 it is determined whether a page fault is identified during the translation. If no page fault is identified, then the SMMU 60 successfully obtains the second address and at step 806 the interface 302 returns the second address to the requesting device in an ATS response (having the U bit set to 0).

However, if a page fault is detected then the second address cannot be returned to the device. At step 808 it is determined whether automatic generation of page requests is enabled for the device (and/or device context) which issued the address translation request. This may involve checking the status of ATS control and configuration registers of the device, or checking state provided within the SMMU 60 corresponding to the ATS control and configuration registers of the device.

If automatic generation of page requests is not enabled, then at step 810 the SMMU 60 sends, via the interface 302, a page fault response to the device indicating that a page fault was encountered. This enables the device to issue its own page request, if desired.

If automatic generation of page requests is enabled, then at step 812 it is determined whether the encountered page fault is correctable. If the page fault is non-correctable, then at step 814 a page fault response is sent to the requesting device to indicate that the page fault is non-correctable, and automatic issuing of a page request is suppressed.

If the page fault is correctable, then at step 816 the SMMU 60 generates, via the page request issuing circuitry 304, a page request token. The page request token is unique for the page request.

At step 818 a page request is issued by the SMMU 60, including the page request token, requesting that the page fault encountered when attempting to translate the first address is corrected. The page request may be issued by writing the page request to a location in memory within a PRI queue structure, the location for example determined by reference to a pointer.

At step 820 the SMMU 60, via the interface 302, sends a page fault response to the requesting device indicating that a page fault was encountered, that a page request has been automatically generated and issued, and including the page request token to allow future responses to the page request to be identified.

It will be appreciated that the order of method steps shown in FIG. 8 is an example, and in practice operations may be carried out in a different order.

Concepts described herein may be embodied in a system comprising at least one packaged chip. The memory management unit described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

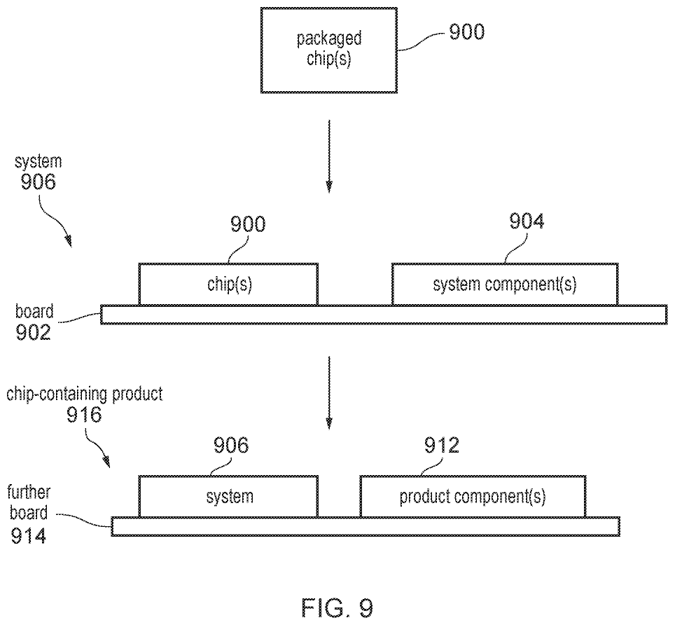

As shown in FIG. 9, one or more packaged chips 900, with the memory management unit described above implemented on one chip or distributed over two or more of the chips, are manufactured by a semiconductor chip manufacturer. In some examples, the chip product 900 made by the semiconductor chip manufacturer may be provided as a semiconductor package which comprises a protective casing (e.g. made of metal, plastic, glass or ceramic) containing the semiconductor devices implementing the memory management unit described above and connectors, such as lands, balls or pins, for connecting the semiconductor devices to an external environment. Where more than one chip 900 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 900 are assembled on a board 902 together with at least one system component 904 to provide a system 906. For example, the board may comprise a printed circuit board. The board substrate may be made of any of a variety of materials, e.g. plastic, glass, ceramic, or a flexible substrate material such as paper, plastic or textile material. The at least one system component 904 comprise one or more external components which are not part of the one or more packaged chip(s) 900. For example, the at least one system component 904 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 916 is manufactured comprising the system 906 (including the board 902, the one or more chips 900 and the at least one system component 904) and one or more product components 912. The product components 912 comprise one or more further components which are not part of the system 906. As a non-exhaustive list of examples, the one or more product components 912 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 906 and one or more product components 912 may be assembled on to a further board 914.

The board 902 or the further board 914 may be provided on or within a device housing or other structural support (e.g. a frame or blade) to provide a product which can be handled by a user and/or is intended for operational use by a person or company.

The system 906 or the chip-containing product 916 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
(1) A memory management unit comprising:
an interface configured to receive an address translation request from a device, the address translation request specifying a first address to be translated;
   translation circuitry configured to translate the first address specified by the address translation request into a second address, wherein the translation is based on page table information corresponding to the first address,
   wherein in response to the translation circuitry performing the translation in response to the address translation request without identifying a page fault associated with the first address, the interface is configured to send an address translation response to the device, the address translation response comprising the second address; and
   the memory management unit comprises page request issuing circuitry responsive to the translation circuitry, in response to the address translation request, identifying a page fault associated with the first address, to issue a page request requesting that the page table information corresponding to the first address is updated to correct the page fault.
(2) The memory management unit according to clause 1, wherein the interface is configured to send a page fault response to the device indicating that the page request issuing circuitry has issued the page request.
(3) The memory management unit according to any preceding clause, wherein the page request issuing circuitry is configured to generate a page request token and assign the page request token to the page request.
(4) The memory management unit according to clause 3,
wherein the interface is configured to send a page fault response to the device indicating that the page request issuing circuitry has issued a page request; and
the page fault response indicates the page request token assigned to the page request.
(5) The memory management unit according to any of clauses 3 and 4, wherein
the interface is configured to send, to the device, a page corrected response in response to determining that the page fault associated with the first address has been corrected; and
   the page corrected response indicates the page request token assigned to the page request.
(6) The memory management unit according to any preceding clause, wherein the page request issuing circuitry is configured to issue the page request to a page request queue.
(7) The memory management unit according to clause 6, wherein the page request queue comprises a queue structure in a region of memory accessible to device management circuitry responsible for controlling the assignment of memory pages.
(8) The memory management unit according to any preceding clause, wherein the translation circuitry is configured to identify a page fault in response to determining that the first address does not correspond to valid page table information or that the page table information corresponding to the first address indicates that the device is not allowed to access a memory location corresponding to the first address.
(9) The memory management unit according to any preceding clause, wherein responsive to the translation circuitry identifying a non-correctable page fault associated with the first address, the interface is configured to send a non-correctable page fault response to the device indicating that a non-correctable page fault was encountered.
(10) The memory management unit according to any preceding clause, wherein the first address is a virtual address and the second address is any one of a physical address directly indicating a memory location, and an intermediate address different from the physical address.
(11) The memory management unit according to any preceding clause, wherein
in a first page fault mode the page request issuing circuitry is responsive to the translation circuitry identifying the page fault in response to the address translation request to issue the page request, and
   in a second page fault mode:
the page request issuing circuitry is responsive to the translation circuitry identifying the page fault in response to the address translation request, to suppress issuing the page request as a response to the address translation request, and
the interface circuitry is responsive to the translation circuitry identifying the page fault in response to the address translation request to send a page fault response, to the device, indicating that the page fault has been encountered.
(12) The memory management unit according to clause 11, wherein the page request issuing circuitry is configured to select whether to use the first page fault mode or the second page fault mode in dependence on control information accessible to the page request issuing circuitry.
(13) The memory management unit according to any preceding clause, wherein the page request identifies a translation context associated with the first address.
(14) A data processing apparatus comprising: a memory management unit according to any preceding clause, and processing circuitry to execute program instructions.
(15) A system comprising:
the memory management unit of any of clauses 1 to 13, implemented in at least one packaged chip;
   at least one system component; and
a board,
wherein the at least one packaged chip and the at least one system component are assembled on the board.
(16) A chip-containing product comprising the system of clause 15 assembled on a further board with at least one other product component.
(17) A non-transitory computer-readable medium to store computer-readable code for fabrication of a memory management unit comprising:
an interface configured to receive an address translation request from a device, the address translation request specifying a first address to be translated;
   translation circuitry configured to translate the first address specified by the address translation request into a second address, wherein the translation is based on page table information corresponding to the first address,
   wherein in response to the translation circuitry performing the translation in response to the address translation request without identifying a page fault associated with the first address, the interface is configured to send an address translation response to the device, the address translation response comprising the second address; and
   the memory management unit comprises page request issuing circuitry responsive to the translation circuitry, in response to the address translation request, identifying a page fault associated with the first address, to issue a page request requesting that the page table information corresponding to the first address is updated to correct the page fault.
(18) A method comprising:
receiving an address translation request from a device, the address translation request specifying a first address to be translated;
   performing a translation from the first address specified by the address translation request into a second address based on page table information corresponding to the first address;
   responsive to the translation being performed without identifying a page fault associated with the first address, sending an address translation response to the device, the address translation response comprising the second address; and
      responsive to the translation identifying a page fault associated with the first address, issuing a page request requesting that the page table information corresponding to the first address is updated to correct the page fault.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A memory management unit comprising:
an interface configured to receive an address translation request from a device, the address translation request specifying a first address to be translated;
translation circuitry configured to translate the first address specified by the address translation request into a second address, wherein the translation is based on page table information corresponding to the first address,
wherein in response to the translation circuitry performing the translation in response to the address translation request without identifying a page fault associated with the first address, the interface is configured to send an address translation response to the device, the address translation response comprising the second address; and
the memory management unit comprises page request issuing circuitry responsive to the translation circuitry, in response to the address translation request, identifying a page fault associated with the first address, to issue a page request requesting that the page table information corresponding to the first address is updated to correct the page fault.

2. The memory management unit according to claim 1, wherein the interface is configured to send a page fault response to the device indicating that the page request issuing circuitry has issued the page request.

3. The memory management unit according to claim 1, wherein the page request issuing circuitry is configured to generate a page request token and assign the page request token to the page request.

4. The memory management unit according to claim 3,
wherein the interface is configured to send a page fault response to the device indicating that the page request issuing circuitry has issued a page request; and
the page fault response indicates the page request token assigned to the page request.

5. The memory management unit according to claim 3, wherein
the interface is configured to send, to the device, a page corrected response in response to determining that the page fault associated with the first address has been corrected; and
the page corrected response indicates the page request token assigned to the page request.

6. The memory management unit according to claim 1, wherein the page request issuing circuitry is configured to issue the page request to a page request queue.

7. The memory management unit according to claim 6, wherein the page request queue comprises a queue structure in a region of memory accessible to device management circuitry responsible for controlling the assignment of memory pages.

8. The memory management unit according to claim 1, wherein the translation circuitry is configured to identify a page fault in response to determining that the first address does not correspond to valid page table information or that the page table information corresponding to the first address indicates that the device is not allowed to access a memory location corresponding to the first address.

9. The memory management unit according to claim 1, wherein responsive to the translation circuitry identifying a non-correctable page fault associated with the first address, the interface is configured to send a non-correctable page fault response to the device indicating that a non-correctable page fault was encountered.

10. The memory management unit according to claim 1, wherein the first address is a virtual address and the second address is any one of a physical address directly indicating a memory location, and an intermediate address different from the physical address.

11. The memory management unit according to claim 1, wherein
in a first page fault mode the page request issuing circuitry is responsive to the translation circuitry identifying the page fault in response to the address translation request to issue the page request, and
in a second page fault mode:
the page request issuing circuitry is responsive to the translation circuitry identifying the page fault in response to the address translation request, to suppress issuing the page request as a response to the address translation request, and
the interface circuitry is responsive to the translation circuitry identifying the page fault in response to the address translation request to send a page fault response, to the device, indicating that the page fault has been encountered.

12. The memory management unit according to claim 11, wherein the page request issuing circuitry is configured to select whether to use the first page fault mode or the second page fault mode in dependence on control information accessible to the page request issuing circuitry.

13. The memory management unit according to claim 1, wherein the page request identifies a translation context associated with the first address.

14. A data processing apparatus comprising: a memory management unit according to claim 1, and processing circuitry to execute program instructions.

15. A system comprising:
the memory management unit of claim 1, implemented in at least one packaged chip;
at least one system component; and
a board,
wherein the at least one packaged chip and the at least one system component are assembled on the board.

16. A chip-containing product comprising the system of claim 15 assembled on a further board with at least one other product component.

17. A non-transitory computer-readable medium to store computer-readable code for fabrication of a memory management unit comprising:
an interface configured to receive an address translation request from a device, the address translation request specifying a first address to be translated;
translation circuitry configured to translate the first address specified by the address translation request into a second address, wherein the translation is based on page table information corresponding to the first address,
wherein in response to the translation circuitry performing the translation in response to the address translation request without identifying a page fault associated with the first address, the interface is configured to send an address translation response to the device, the address translation response comprising the second address; and
the memory management unit comprises page request issuing circuitry responsive to the translation circuitry, in response to the address translation request, identifying a page fault associated with the first address, to issue a page request requesting that the page table information corresponding to the first address is updated to correct the page fault.

18. A method comprising:
receiving an address translation request from a device, the address translation request specifying a first address to be translated;
performing a translation from the first address specified by the address translation request into a second address based on page table information corresponding to the first address;
responsive to the translation being performed without identifying a page fault associated with the first address, sending an address translation response to the device, the address translation response comprising the second address; and
responsive to the translation identifying a page fault associated with the first address, issuing a page request requesting that the page table information corresponding to the first address is updated to correct the page fault.
